(19) United States
(12) Patent Application Publication
(10) Pub. No.: US 2020/0175377 A1
(43) Pub. Date: Jun. 4, 2020

(54) TRAINING APPARATUS, PROCESSING APPARATUS, NEURAL NETWORK, TRAINING METHOD, AND MEDIUM

(71) Applicant: CANON KABUSHIKI KAISHA, Tokyo (JP)

(72) Inventors: Yuichiro Iio, Tokyo (JP); Takayuki Saruta, Tokyo (JP)

(21) Appl. No.: 16/693,025

(22) Filed: Nov. 22, 2019

(30) Foreign Application Priority Data
Dec. 3, 2018 (JP) 2018-226721

(51) Int. Cl. G06N 3/08; G06N 20/00

(52) U.S. Cl. CPC G06N 3/084; G06N 20/00

(57) ABSTRACT

There is provided with a training apparatus for training a neural network. The neural network, when an input image is inputted, outputs a detection result of a first type and a detection result of a second type for each position of the input image. A training data obtaining unit obtains a training image to be input to the neural network for training. An error map obtaining unit obtains an error map indicating a detection error for a detection result of the first type, for each position of the training image. A training unit trains the neural network using the detection result of the first type and the detection result of the second type that are obtained by inputting the training image to the neural network, and the error map.

### BACKGROUND OF THE INVENTION

### Field of the Invention

The present invention relates to a training apparatus, a processing apparatus, a neural network, a training method, and a medium, and particularly relates to an image recognition technology.

### Description of the Related Art

Detection processing for data such as images or sound is known. In this specification, the purpose of a detection process is referred to as a recognition task. A variety of recognition tasks are known, such as a task for detecting human facial regions from an image, a task for determining a category of objects (subjects) in an image (such as cats, cars, or buildings), and a task for determining a category of scenes (such as city, mountain area, or coastal area). A training process for the performance of such a recognition task is also known. For example, neural networks, particularly Deep Neural Networks (DNN), have received attention in recent years because of their high performance.

A neural network comprises an input layer to which data is input, a plurality of intermediate layers, and an output layer for outputting a detection result. In the training phase, when the training data is input to the neural network, a loss indicating the difference between an estimation result obtained from the output layer and supervisory data indicating the correct detection result for the training data is calculated according to a preset loss function. Training proceeds by, for example, adjusting the coefficients of the neural network so as to reduce the loss by using back propagation (BP) or the like. For example, in a task of detecting a region in an image where a target is present, when the image is input to a neural network, a label for each region of the image (an estimation result of whether the target is present) is obtained. In this case, the supervisory image labeled for each region of the image is used as the supervisory data for the training data (training image), and the accuracy of the detection result can be improved by performing training using the total loss which is the sum of the losses for the respective pixels.

Szegedy (Christian Szegedy, Wei Liu, Yangqing Jia, Pierre Sermanet, Scott Reed, Dragomir Anguelov, Dumitru Erhan, Vincent Vanhoucke, and Andrew Rabinovich. “Going deeper with convolutions” in CVPR, 2015.) further discloses, in addition to an output layer connected to a final layer of the neural network, connecting an output layer to an intermediate layer. The loss of an estimation result obtained from the output layer of the intermediate layer is calculated using the same supervisory data as that of the output layer of the final layer, thereby improving the training efficiency in the intermediate layer which is separated from the final layer. Also known is a technique of multi-task training in which a plurality of related tasks are trained at the same time. For example, Japanese Patent Laid-Open No. 2016-6626 discloses a technique for improving the detection accuracy of the position of a person by simultaneously performing training of a task for identifying whether or not a person is present in an input image and a task for obtaining a regression result indicating the position of the person in the input image.

On the other hand, hard negative training is known as a technique for improving detection accuracy. In hard negative training, training is performed again by preferentially using a training image in which misdetection has occurred, thereby suppressing the misdetection. Hard positive training is also known in which training images for which underdetection has occurred are preferentially used for training to prevent underdetection. For example, in Shrivastava (Abhinav Shrivastava, Abhinav Gupta, Ross Girshick, “Training Region-Based Object Detectors with Online Hard Example Mining”, in CVPR, 2016.), a target detecting process is performed using a neural network that has been trained. Then, a partial image including a region in which misdetection has occurred is preferentially used as a training image in training again.

### SUMMARY OF THE INVENTION

According to an embodiment of the present invention, a training apparatus for training a neural network, the neural network being configured to, when an input image is inputted, output a detection result of a first type and a detection result of a second type for each position of the input image, comprises: a training data obtaining unit configured to obtain a training image to be input to the neural network for training; an error map obtaining unit configured to obtain an error map indicating a detection error for a detection result of the first type, for each position of the training image; and a training unit configured to train the neural network using the detection result of the first type and the detection result of the second type that are obtained by inputting the training image to the neural network, and the error map.

According to another embodiment of the present invention, a processing apparatus for outputting an estimation map, the estimation map indicating a detection result for each position of an input image, comprises: a neural network trained by a training apparatus, the neural network being configured to, when the input image is inputted, output the detection result of a first type and the detection result of a second type for each position of the input image, the training apparatus comprising: a training data obtaining unit configured to obtain a training image to be input to the neural network for training; an error map obtaining unit configured to obtain an error map indicating a detection error for a detection result of the first type, for each position of the training image; and a training unit configured to train the neural network using the detection result of the first type and the detection result of the second type that are obtained by inputting the training image to the neural network, and the error map; and a generation unit configured to generate the estimation map by inputting input images to the neural network.

According to still another embodiment of the present invention, a neural network for outputting, as an estimation map, a detection result for each position of an input image, comprises: an input layer to which the input image is inputted; an intermediate layer in which processing is performed; and an output layer configured to output the detection result, wherein the neural network is trained such that a different detection result that can be generated from the detection result is obtained from the intermediate layer.

According to yet another embodiment of the present invention, a method of training a neural network, the neural network being configured to, when an input image is inputted, output a detection result of a first type and a detection result of a second type for each position of the input image, comprises: obtaining a training image to be input to the neural network for training; obtaining an error map indicating a detection error for a detection result of the first type, for each position of the training image; and training the neural network using the detection result of the first type and the detection result of the second type that are obtained by inputting the training image to the neural network, and the error map.

According to still yet another embodiment of the present invention, a non-transitory computer-readable medium stores a program which, when executed by a computer comprising a processor and a memory, causes the computer to perform: obtaining a training image to be input to the neural network for training, the neural network being configured to, when an input image is inputted, output a detection result of a first type and a detection result of a second type for each position of the input image, obtaining an error map indicating a detection error for a detection result of the first type, for each position of the training image; and training the neural network using the detection result of the first type and the detection result of the second type that are obtained by inputting the training image to the neural network, and the error map.

Further features of the present invention will become apparent from the following description of exemplary embodiments (with reference to the attached drawings).

### BRIEF DESCRIPTION OF THE DRAWINGS

FIG. 1 is a schematic diagram illustrating a functional configuration of a processing apparatus according to one embodiment.

FIGS. 2A to 2C are schematic diagrams illustrating examples of region detection tasks.

FIG. 3 is a schematic diagram for explaining the flow of processing for training a neural network.

FIG. 4 is a flowchart illustrating a training method according to an embodiment.

FIGS. 5A and 5B are schematic diagrams illustrating an example of a sub-task setting method.

FIGS. 6A to 6D are schematic diagrams illustrating an example of a method of generating a supervisory image of a sub-task.

FIGS. 7A to 7D are schematic diagrams illustrating an example of a method of generating an error map.

FIG. 8 is a schematic diagram illustrating a functional configuration of a processing apparatus according to one embodiment.

FIG. 9 is a flowchart illustrating a training method according to an embodiment.

FIG. 10 is a schematic diagram illustrating a hardware configuration of a processing apparatus according to one embodiment.

FIG. 11 is a schematic diagram illustrating an example of a sub-task setting method.

### DESCRIPTION OF THE EMBODIMENTS

There has been a desire to train neural networks more efficiently.

An embodiment of the present invention can improve the training efficiency of a neural network.

Hereinafter, embodiments for working the present invention will be described with reference to the drawings. However, the scope of the present invention is not limited to the following embodiments.

A training apparatus according to one embodiment performs training of a neural network that outputs a detection result for each position of an input image as an estimation map. In particular, the training apparatus according to the present embodiment calculates an error map indicating error between a detection result obtained by inputting a training image into a neural network, and supervisory data for each position of the training image. This error map indicates the presence of a subject that is likely to suffer misdetection (false positive) or underdetection (false negative) in the image detection process for each position of the training image, and further indicates the ease of the image detection process, so that it can be used for optimizing the training process.

### First Embodiment

In the first embodiment, an error map is used for weighting regions in which image detection processing is difficult in processing for training a neural network. In Shrivastava, a partial image which includes a region in which misdetection has occurred is itself used as a hard negative sample. That is, a region in which the determination is correct among the partial images is also preferentially used in the training process. On the other hand, according to the present embodiment, it is possible to weight only a region of the image in which image detection processing is difficult, so that training efficiency can be further increased.

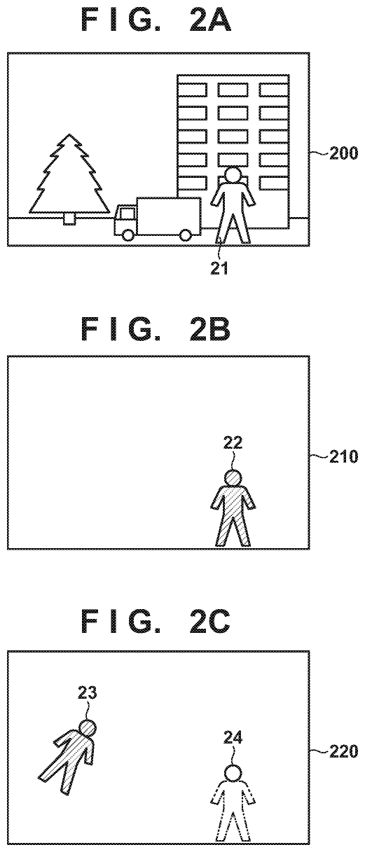

Hereinafter, a training apparatus according to the first embodiment will be described. In the present embodiment, the training of the neural network of a neural network processing apparatus is performed so that a recognition task of a region can be performed with high accuracy. A region recognition task is a task for estimating a region in which a detection target is present in an input image. For example, when inputted with the image 200 illustrated in FIG. 2A and able to perform estimation correctly, the DNN that performs the recognition task of the region, which takes a human body as a detection target, outputs information indicating a human body region 22 where a human body is present as with an image 210 illustrated in FIG. 2B. On the other hand, when the estimation fails, a region 23 in which a human body is not present is determined as a human body region (misdetection), and the region 24 in which the human body is present is not determined as the human body region (underdetection), as in an image 220 illustrated in FIG. 2C. In the present embodiment, training of a DNN for performing a recognition task of a region is efficiently performed so that misdetection and underdetection are suppressed.

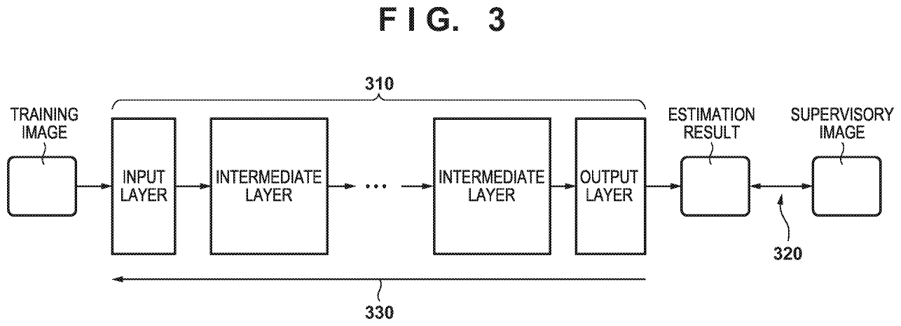

First, a typical flow of the execution process of the recognition task of the region using a DNN and the training process of the DNN will be described with reference to FIG. 3. When inputted with an image of a detection target, the DNN outputs a region detection result corresponding to the image. For example, when an image of a detection target is input to an input layer, an estimation map as an estimation result is output from an output layer through intermediate layers. Each layer of the DNN holds a weighting coefficient which is a trained parameter. Each layer performs a weighting process on the input from the previous layer, for example, a convolution operation, and passes the result to the next layer. By sequentially executing such processing, the estimation map is output from the output layer.

The estimation map is a two-dimensional map illustrating the detection result for each position of the input image. For example, the estimation map may present a region in which a detection target is estimated to be present. The DNN can output, for example, an estimation map composed of a label (pixel value) for each position of an image of a detection target, corresponding to the image of the detection target. In the present embodiment, this pixel value can take a value that is greater than or equal to 0 and less than or equal to 1. A pixel value close to 1 means a higher estimation probability of the target being present at the corresponding position of the image of the detection target. On the other hand, when the pixel value is close to 0, it means a lower estimation probability of the target being present. However, the configuration of an estimation map is not limited to such a specific example.

In the training of a DNN which performs the recognition task of such a region, a pair of a training image and a supervisory image can be used as training data. The training image is an arbitrary image, and may be, for example, an RGB image. The supervisory image is data indicating the region detection result of the training image, and can be created in advance, for example manually. In the present embodiment, a supervisory image is configured by a label for each position of a training image. In the following description, the supervisory image has a label (for example, pixel value 1) indicating that a detection target is present in a region where the detection target is present, and has a label (for example, pixel value 0) indicating that the detection target is not present in a region where the detection target is not present.

In the training process, firstly, by comparing the output of the DNN obtained by inputting the training image with the supervisory image, an output error is obtained. For example, as in the process 310 of FIG. 3, by inputting the training image to the DNN, an estimation map corresponding to the training image is obtained. Next, as in the process 320 of FIG. 3, the loss is calculated by comparing the estimation map corresponding to the training image with the supervisory image. The loss is a value indicating the error of the output. The loss can be calculated using a preset loss function. For example, as the loss function E in the recognition task of the region, cross entropy error illustrated in Equation (1) can be adopted. However, the loss function is not limited to this, and can be appropriately selected in accordance with the detection target.

E=−Σ_{q}Σₚt_{(p,q)}log y_{(p,q)} (1)

In Equation (1), let the pixel value of coordinates (p, q) in the estimation map be y_{(p, q)}. In addition, let t_{(p,q)} be the pixel value of the coordinates (p, q) in a supervisory image.

Finally, as in the process 330 of FIG. 3, the weighting coefficient of each layer of the DNN is updated based on the obtained output error. For example, as introduced in Szegedy or the like, the weighting coefficient can be updated by using back propagation (BP) or the like based on the obtained loss.

By repeating the processes 310 to 330 illustrated in FIG. 3 and successively updating the weighting coefficient of each layer, the loss gradually decreases, that is, the estimation map approaches the supervisory image. In this manner, DNN training processing can be performed.

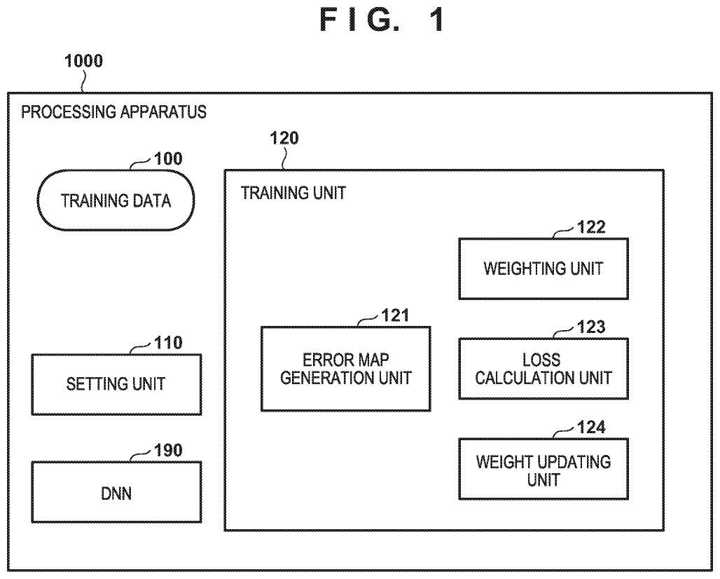

Hereinafter, the configuration of the training apparatus according to the present embodiment will be described with reference to FIG. 1. A processing apparatus 1000 has a DNN 190 as a neural network, and upon being input with an input image, the DNN 190 outputs detection results for respective positions of the input image as an estimation map. The DNN 190 is trained so as to detect a specific target, and the task of detecting the specific target is called a main task. The detection result of the specific target that is outputted from the neural network may be referred to as a detection result of a first type or an estimation map of the main task. In the present embodiment, the processing apparatus 1000 also operates as a training apparatus that trains the DNN 190. Hereinafter, a configuration for training the DNN 190 that is included in the processing apparatus 1000 will be described.

The processing apparatus 1000 includes a setting unit 110 and a training unit 120. The processing apparatus 1000 has training data 100. The training data 100 is an image set composed of a plurality of training images and a supervisory image corresponding to each training image. A supervisory image indicates a region in a training image in which a detection target of the main task is present, and may be referred to below as first supervisory data or a supervisory image of the main task.

The setting unit 110 can perform training data obtainment, which is obtaining a training image to be inputted to the neural network for training. As described above, the processing apparatus 1000 may have training images as the training data 100, or the setting unit 110 may obtain training images from an external unit.

The setting unit 110 also performs sub-task setting. In the present embodiment, the main task is a recognition task for performing estimation using the DNN 190, and the result of the recognition task is output from the output layer of the DNN 190. Meanwhile, in the present embodiment, a sub-task is a task for detecting a detection target similar to the detection target of the main task.

The sub-task is a task different from the main task, but may be a recognition task related to the same category as the main task. A recognition task related to the same category as the main task refers to a recognition task that targets a detection target of the main task or a recognition task related to a detection target of the main task. In one embodiment, the detection results of a main task and the detection result of a sub-task indicate different information for the same type of detection target. For example, in the case of FIGS. 2A to 2C, a recognition task for a human body region corresponds to the main task. Specific examples of a sub-task in this case include tasks related to a human body region, and specific examples include tasks for detecting a central region of a human body. The detection target of a sub-task may be a portion (for example, a head, a hand, or a foot) of the detection target of the main task (for example, a human body).

As in a third embodiment, the detection target of a sub-task may be a subject having a feature similar to that of the detection target of the main task, or a region in which the detection target of the main task is likely to suffer misrecognition. As a further example, the relationship between the main task and the sub-task may be a relationship in which a detection result of the sub-task can be generated from a detection result of the main task.

The method of setting the sub-task is not particularly limited. A specific type of sub-task may be defined in advance corresponding to the main task or may be defined by the user. In this specification, a result of a sub-task outputted from a neural network is referred to as a detection result of a second type or an estimation map of the sub-task. When an input image is input, the DNN 190 can output, as an estimation map, a detection result of a second type for each position of the input image.

The setting unit 110 can obtain first supervisory data (or a supervisory image of a main task) indicating a detection result of the first type and second supervisory data (or a supervisory image of a sub-task) indicating a detection result of the second type, which are prepared in advance for a training image. As described above, the processing apparatus 1000 may have, as the training data 100, a supervisory image, which is prepared in advance, of the main task corresponding to a training image. The setting unit 110 may obtain a supervisory image of the main task from an external unit.

However, when the detection result of a sub-task can be generated from the detection result of a main task, the setting unit 110 may generate the second supervisory data (or the supervisory image of the sub-task) using the first supervisory data (or the supervisory image of the main task). That is, the setting unit 110 can generate a supervisory image of a sub-task corresponding to the training image from the supervisory image of the main task corresponding to the training image. A supervisory image for a sub-task indicates a region in the training image where the detection target of the sub-task is present, and may be referred to as second supervisory data. Processing by the setting unit 110 to generate the supervisory image of a sub-task will be described later. On the other hand, the supervisory image for a sub-task may be generated in advance, or the setting unit 110 may obtain the supervisory image from an external unit.

Further, the setting unit 110 may configure the DNN 190 to perform a sub-task in addition to the main task. In one embodiment, the DNN 190 includes an input layer into which input images are inputted, an intermediate layer in which processing is performed, a first output layer for outputting a detection result of the first type, and a second output layer that branches from the intermediate layer and outputs a detection result of the second type. Here, the intermediate layer may have a plurality of convolution layers, and the second output layer may branch from between the plurality of convolution layers in the intermediate layer. A further intermediate layer may also be present between the branch point and the second output layer.

For example, the setting unit 110 can configure the DNN 190, which outputs the estimation map of the main task from an output layer, so that the network branches in the intermediate layer. A further output layer is connected to the branched network, and an estimation map of a sub-task is output from this further output layer. The method of configuring the DNN 190 for performing the sub-task is not particularly limited, and for example, the setting unit 110 may configure the DNN 190 by using a method selected from a predefined network-branching method. On the other hand, the DNN 190 may be configured in advance to perform a sub-task in addition to the main task, or may be configured by a user.

The training unit 120 is a processing unit that performs DNN 190 training processing. The training unit 120 includes an error map generation unit 121, a weighting unit 122, a loss calculation unit 123, and a weight updating unit 124.

The error map generation unit 121 performs error map obtainment for obtaining an error map indicating a detection error in the detection result of the first type for each position of the training image. For example, the error map generation unit 121 can create an error map based on the error between the detection result of the first type obtained by inputting the training image to the neural network, and the first supervisory data. For this purpose, the error map generation unit 121 can input the training image to the DNN 190, and obtain an estimation map of the main task as an output from the neural network. Then, the error map generation unit 121 can generate an error map indicating the error distribution between the estimation map of the main task and the supervisory image corresponding to the training image. In this manner, the error map generation unit 121 can create an error map corresponding to a specific training image. On the other hand, it is not necessary for the error map generation unit 121 to create an error map using the current neural network. Similar to in the second embodiment, the error map generation unit 121 may obtain an error map generated using a previous neural network.

The error map in the present embodiment is a map in which the error distribution between the estimation result of the main task and the supervisory image is visualized. The error map in the present embodiment indicates the position of an underdetection region or misdetection region caused by the detection error in the detection result of the first type. In one embodiment, misdetection or underdetection regions for the main task may be represented as regions having large numerical values on the map. Details of the processing will be described later.

The weighting unit 122 uses the detection error in the detection result of the first type to weight the error between the detection result of the second type and the second supervisory data. The weighting unit 122 can use the error map generated for the training image by the error map generation unit 121 to weight the error for each position of the training image. In addition, it is possible for the weighting unit 122 to input a training image to the neural network, and obtain an estimation map of the sub-task as an output from the neural network. Details of the processing will be described later.

The loss calculation unit 123 and the weight updating unit 124 train the neural network using the detection result of the first type and the detection result of the second type that are obtained by inputting the training image to the neural network, and the error map. In the present embodiment, the loss calculation unit 123 and the weight updating unit 124 train the neural network based on the error between the detection result of the first type and the first supervisory data, and the error between the detection result of the second type and the second supervisory data.

For example, the loss calculation unit 123 can evaluate the error between the detection result of the first type for the main task, and the first supervisory data. That is, the loss calculation unit 123 can calculate the loss of the main task from the estimation map of the main task and a first supervisory image. In addition, the loss calculation unit 123 can evaluate the error between the second supervisory data and the detection result of the second type relating to the sub-task. That is, the loss calculation unit 123 can calculate the loss of the sub-task from the estimation map of the sub-task and a second supervisory image. At this time, the loss calculation unit 123 weights the error between the detection result of the second type and the second supervisory data for each position of the training image according to the weighting by the weighting unit 122. That is, the loss calculation unit 123 weights the loss of the sub-task for each position of the training image, and calculates the loss of the sub-task. A specific example of the processing will be described later.

The weight updating unit 124 updates the weights of layers of the DNN 190 according to the loss calculated by the loss calculation unit 123. The weight updating unit 124 can update the weight coefficients of each layer by using a standard method used for training a neural network. For example, the weight updating unit 124 can update the weight using back propagation which is mentioned above.

Each of the processing units illustrated in FIG. 1 and the like can be realized by a computer. FIG. 10 is a diagram illustrating a basic configuration of a computer that can be used as the processing apparatus 1000. In FIG. 10, a processor 1010 is, for example, a CPU, and controls the operation of the entire computer. The memory 1020 is, for example, a RAM, and temporarily stores programs, data, and the like. The computer-readable storage medium 1030 is, for example, a hard disk, a CD-ROM, or the like, and stores programs, data, and the like over a long period of time. In the present embodiment, a program that is for realizing the functions of the respective units and is stored in the storage medium 1030 is read out to the memory 1020. The processor 1010 operates in accordance with a program in the memory 1020, thereby realizing the functions of the respective units. On the other hand, one or more of the processing units illustrated in FIG. 1 and the like may be realized by dedicated hardware.

In addition, a neural network such as the DNN 190 can be realized as a program that performs sequential operations in accordance with weighting coefficients. The DNN 190 can also be realized by a processor such as a processor configured to perform sequential operations in accordance with the weighting coefficients.

In FIG. 10, an input interface 1040 is an interface for obtaining information from an external apparatus. In addition, an output interface 1050 is an interface for outputting information to an external apparatus. A bus 1060 connects the above-mentioned units and enables data exchange.

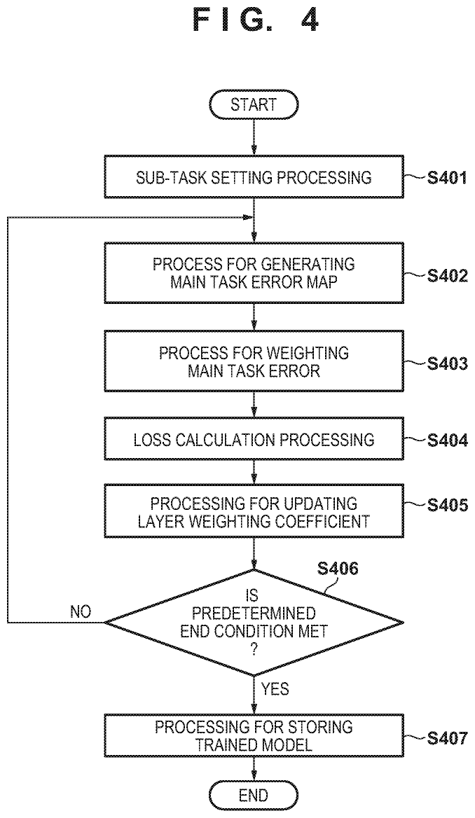

Hereinafter, the flow of processing of the neural network processing apparatus according to the present embodiment will be described in detail with reference to the flowchart illustrated in FIG. 4.

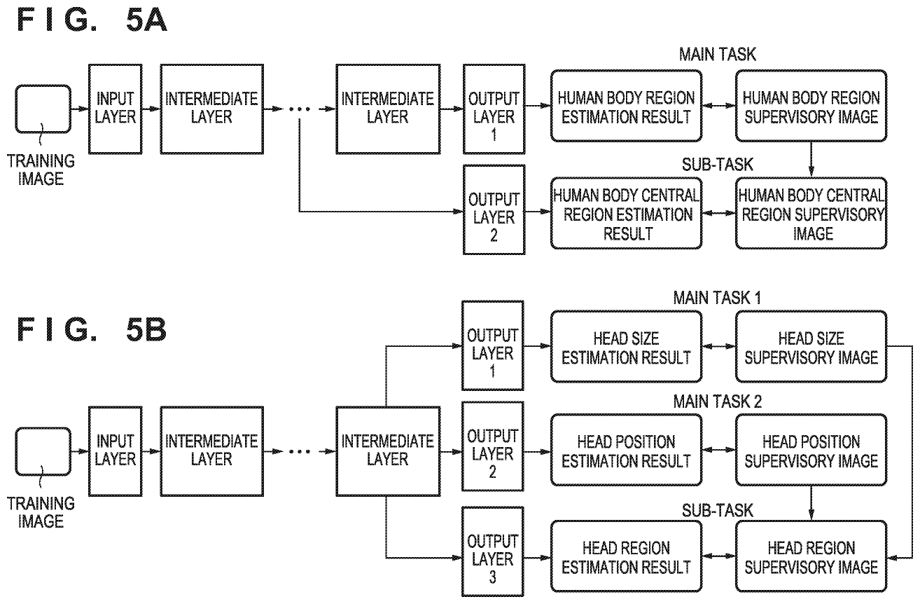

In step S401, the setting unit 110 sets a sub-task as described above, and configures the DNN 190 so as to simultaneously estimate the main task and the sub-task. FIG. 5A illustrates an example of the DNN 190 which is used when detecting a human body region as a main task and detecting a central region of a human body as a sub-task. In the present embodiment, as illustrated in FIG. 5A, the output layer that outputs the result of the sub-task branches from the intermediate layer instead of the final layer.

However, an example of a configuration of the neural network is not limited to a configuration in which the results of the sub-tasks are obtained from the intermediate layers as illustrated in FIG. 5A. For example, a multi-tasking neural network may be employed in which an output layer that outputs the result of the main task and an output layer that outputs the result of the sub-task are both obtained from a final layer. For example, FIG. 5B illustrates an example where, with respect to a neural network where a task for detecting a face central region and a task for estimating a face size are main tasks, a task for detecting a face region in the final layer is set as a sub-task.

A sub-task in the present embodiment is a recognition task relating to the same category as that of the main task. Therefore, by training the neural network so as to improve the estimation accuracy of the sub-task, the training of the neural network proceeds so that it is easier to extract a feature of the detection target. Therefore, the estimation accuracy of the main task can be increased. In particular, when the result of a sub-task is obtained from an intermediate layer, as in FIG. 5A, sub-task-based training can be performed from an intermediate layer (closer to the input layer, in other words a shallow layer). Therefore, it is possible to efficiently perform training for extracting features useful for estimation in the main task in a shallow layer of the neural network.

As described above, the setting unit 110 can automatically create supervisory data of the sub-task from the supervisory data of the main task when setting the sub-task. When the DNN illustrated in FIG. 5A is used, the setting unit 110 can create an image indicating a human body central region, which is a supervisory image of a sub-task, from an image indicating a human body region, which is a supervisory image of a main task.

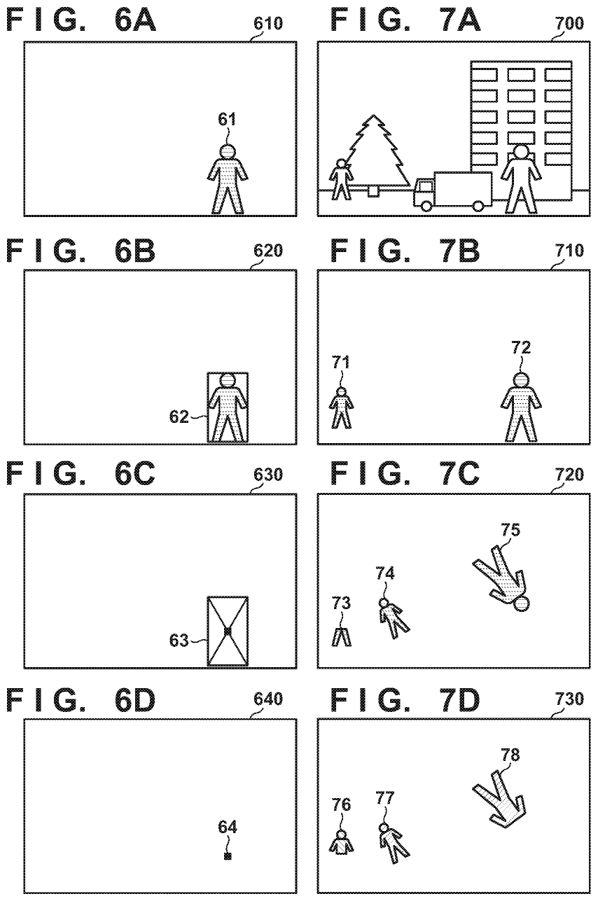

Specific methods are not particularly limited, but examples are illustrated in FIGS. 6A to 6D. First, the setting unit 110 determines a human body region from the supervisory image 610 for a human body region recognition task that is illustrated in FIG. 6A. For example, a human body region can be detected by searching for a set of pixels having a pixel value of 1 among adjacent pixels in the supervisory image 610. Although the supervisory image 610 includes only a region 61 as a human body region, a plurality of human body regions may be present in a supervisory image.

Next, the setting unit 110 determines, for each detected human body region, a rectangular region 62 that includes the human body region, as illustrated in FIG. 6B which illustrates the result of an intermediate process. Further, the setting unit 110 calculates the center position of the determined rectangular region 63 as illustrated in FIG. 6C which illustrates the result of an intermediate process. The human body central region can be represented by the pixel at the center position calculated in this manner. The setting unit 110 calculates a center position for each human body region, and generates an image 640 representing the calculated center position as a supervisory image of the task of detecting the central region of the human body.

Similarly, when the DNN illustrated in FIG. 5B is used, the setting unit 110 can generate a supervisory image of a sub-task for indicating a face region by using a supervisory image indicating a central region of the face, which is a supervisory image of the main task, and a supervisory image indicating the size of the face. For example, the setting unit 110 can use a supervisory image (head position supervisory image) indicating a central region of a face and a supervisory image (head size supervisory image) indicating a size of the face to generate a supervisory image (head region supervisory image) indicating a face region as a circular region. By using the supervisory images generated in this manner, error evaluation and training of the sub-task can be performed.

In step S402, the error map generation unit 121 inputs a training image to the DNN 190, thereby obtaining an estimation map of the main task.

Furthermore, the error map generation unit 121 generates an error map of the main task using the estimation map of the main task and the supervisory image.

Referring to FIGS. 7A to 7D, an example of a method for generating an error map will be described. Here, an explanation will be given for a case of performing, as a main task, person region detection with respect to an input image 700 of FIG. 7A. FIG. 7B illustrates a supervisory image 710 of the main task in this instance. In the supervisory image 710, regions 71 and 72 are labeled as human body regions (in other words, these regions of the supervisory image have pixel values of 1). Other regions are labeled as non-human-body regions (in other words, these regions of the supervisory image have pixel values of 0). Further, FIG. 7C is an estimation map 720 representing the estimation result of the main task, obtained by inputting the input image 700 to the DNN 190. An example of an error map in this case is an error map 730 illustrated in FIG. 7D.

As illustrated in the region 73, in the estimation map 720, the lower body of the region 71 is detected, but the upper body suffers underdetection. Therefore, in the error map 730, the upper body of the region 71 is illustrated as the underdetection region 76. Similarly, in the estimation map 720, the human body region 75 is detected, and in the error map 730, a region other than the head of the region 72 is illustrated as a misdetection region 78 (note that an underdetection region of the region 72 is omitted in FIG. 7C). Further, although the estimation map 720 indicates that a human body is present in the region 74, since there is no human body in this region in the input image 700, this region is illustrated as a misdetection region 77 in the error map 730.

The error map generation unit 121 may present the created error map 730 to a user as an intermediate result of the training process. For example, the error map generation unit 121 can display the input image 700 and the error map 730 together on a display unit (not illustrated) during training. According to such a display, the user can confirm the progress of the training and the tendency of a misdetection or underdetection region to appear. Furthermore, by checking the presented error map 730, the user can modify a hyper-parameter (a training parameter that the user can set in advance), such as the training rate of the DNN 190 or a magnitude of weighting by the weighting unit 122.

An example of generation of a specific error map by the error map generation unit 121 will be described. In the present embodiment, the estimation map is output as a real number distribution. Therefore, out of a human body region illustrated in a supervisory image, the error map generation unit 121 can record a region having a pixel value less than a predetermined threshold value (for example, 0.5) in the estimation map, as an underdetection region in the error map. Similarly, from a non-human-body region illustrated in the supervisory image, the error map generation unit 121 can record a region having a pixel value equal to or larger than a predetermined threshold value as a misdetection region in the error map.

In the error map, an underdetection region and a misdetection region may be recorded so as to be distinguishable from each other. For example, the error map may be a two-channel map of the same size as the supervisory image. Here, in a channel 1, it is possible to set the pixel value of an underdetection region to 1, and set the pixel value of other regions to 0. Here, in a channel 2, it is possible to set the pixel value of a misdetection region to 1, and set the pixel value of other regions to 0.

By the above process, the error map generation unit 121 can generate an error map each time a training image is inputted to the DNN 190 and an estimation map is outputted. By such processing, error maps respectively corresponding to the training images are obtained. However, a specific method of creating the error map is not limited to the above-described method. In addition, a user who has confirmed the presented error map may modify the method of generating an error map at any time. Also, a type of error map is not limited to the one described above. For example, the error map may indicate the possibility that misdetection (or overdetection) occurs at each position by a value that is greater than or equal to 0 and less than or equal to 1.

In step S403, the weighting unit 122 inputs a training image to the DNN 190, thereby obtaining an estimation map of the sub-task. Furthermore, the weighting unit 122 weights the loss of the sub-task for each position of the training image using the error map of the main task created in step S402.

In the present embodiment, the weighting unit 122 decides a weight for each pixel of the sub-task estimation map corresponding to each position of the training image, based on the error map of the main task. The weighting unit 122 can decide the weight by referring to the information of the pixel of the error map of the main task corresponding to a pixel of the estimation map of the sub-task.

For example, the weighting unit 122 can set the weight of a pixel of interest to a when the pixel of interest in the sub-task estimation map is in an underdetection region of the main task. Here, the weighting unit 122 may set the weight of a pixel of interest to a when the pixel of interest of the sub-task estimation map is in an underdetection region of the main task and the detection target of the sub-task is present at the pixel of interest. Whether or not a pixel of interest of a sub-task estimation map is in an underdetection region of the main task can be determined by referring to the error map of the main task. Furthermore, whether or not a detection target of the sub-task is present at the pixel of interest of the estimation map of the sub-task can be determined by referring to the supervisory image of the sub-task. Also, the weighting unit 122 can set the weight of a pixel of interest to P when the pixel of interest in the sub-task estimation map is in a misdetection region of the main task. Here, the weighting unit 122 may set the weight of a pixel of interest to P when the pixel of interest of the sub-task estimation map is in a misdetection region of the main task and the detection target of the sub-task is not present at the pixel of interest. When the pixel of interest does not satisfy the above condition, the weighting unit 122 may set the weight of the pixel of interest to 1. These values a and 0 are any real number that is greater than or equal to 1 and can be set by a user in advance or during processing.

In step S404, the loss calculation unit 123 calculates the loss of the main task based on the estimation map of the main task and the supervisory image of the main task. The calculation of the loss of the main task can be performed, for example, according to Equation (1) described above. In addition, the loss calculation unit 123 calculates the loss of a sub-task based on the estimation map of the sub-task and the supervisory image of the sub-task in accordance with the weighting in step S403. For example, the loss calculation unit 123 can calculate the loss of the sub-task by calculating the loss for each pixel and performing weighted addition of the loss for each pixel using the weight set in step S403. As an example, the loss calculation unit 123 can calculate the loss of the sub-task according to Equation (2). In Equation (2), w_{(p, q)} represents the weight of the coordinates (p, q) of the sub-task estimation map.

E=−Σ_{q}Σₚw_{(p,q)}t_{(p,q)}log y_{(p,q)} (2)

Through such processing, the loss of the sub-task is calculated so that the loss of the sub-task becomes large when a detection error of the sub-task occurs in a region where misdetection or underdetection occurs in the main task. Note that the loss function for calculating the loss need not be the same between the main task and the sub-task, and the loss function can be appropriately set according to the content of a task.

In step S405, the weight updating unit 124 updates the weight coefficients of the respective layers of the DNN 190 as described above based on the loss calculated in step S404. For example, the weight updating unit 124 may update the weight coefficients of the DNN 190 according to back propagation using total loss calculated based on the loss of the main task and the loss of the sub-task.

In step S406, the weight updating unit 124 determines whether or not a predetermined training end condition is satisfied. If the end condition is not satisfied, the process returns to step S402, and then the process of step S402 to step S405 is repeated until the end condition is satisfied. When the processing is repeated, the processing of step S402 to step S405 may be performed using a new training image, or may be performed again using a training image used previously. If the end condition is satisfied, the DNN 190 training process ends, and the process proceeds to step S407.

The end condition is not particularly limited, and may be set in advance by the user. For example, when the training process of step S402 to step S405 has been performed a predetermined number of times, the training process can end. In addition, the training process may end when the detection accuracy of the DNN 190 exceeds a predetermined threshold value. This detection accuracy can be determined, for example, by performing detection processing on a test set which is configured by a set of a training image and a supervisory image prepared in advance.

In step S407, the weight updating unit 124 stores the DNN 190 after training has been performed as a trained model. For example, the weight updating unit 124 can store a trained model by storing the weight coefficients of the respective layers of the DNN 190.

In accordance with one embodiment, by the processing apparatus 1000, a neural network that outputs a detection result for each position of an input image as an estimation map is obtained. This neural network includes an input layer to which an input image is input, an intermediate layer in which processing is performed, and an output layer for outputting a detection result (or a result of a main task). The neural network is trained so that a different detection result (or a result of a sub-task) that can be generated from the detection result is obtained from the intermediate layer.

The processing apparatus 1000 can, for example, obtain an estimation result of the main task for an unknown image by inputting the unknown image to the DNN 190 after training is performed. That is, in one embodiment, the processing apparatus 1000 has a neural network that has been trained as described above. Then, by inputting an input image to the neural network, the processing apparatus 1000 can generate an estimation map indicating the detection result for each position of an input image, and output the estimation map. On the other hand, a separate processing apparatus that has obtained the trained model may similarly generate and output an estimation result of the main task for an unknown image.

Note that the trained model thus obtained may or may not output the estimation result of the sub-task. In addition, when storing the trained model, a user may be able to select whether or not the trained model outputs the estimation result of the sub-task. The weight updating unit 124 may configure the trained model to output an estimation result of the sub-task or not to output the estimation result according to a selection by a user.

According to the configuration of the present embodiment, in the training of a neural network for detecting a region in which a detection target is present, detection error is evaluated while weighting a region for which detection is likely to have an error, and the training of the neural network is performed based on an evaluation result. That is, the detection error of the sub-task in a region in which misdetection or underdetection occurs in the main task is evaluated as high. By performing training of the DNN 190 based on such loss evaluation, efficient training is performed so as to preferentially suppress a detection error of a sub-task in such a region. A sub-task in the present embodiment is a recognition task relating to the same category as that of the main task. Therefore, by training the neural network so as to improve the estimation accuracy of the sub-task, it is possible to train the neural network so that it is easier to extract a feature of the detection target of the main task. As described above, according to the configuration of the present embodiment, training can be efficiently performed so that occurrence of misdetection or underdetection in the main task is suppressed.

In the present embodiment, the weighting of the loss of a sub-task is performed based on the error map of the main task, but the weighting of the loss of the main task may be performed instead based on the error map of a sub-task. The error map generation unit 121 can create an error map for a sub-task similarly to as with the main task. Even in such a case, detection errors in the main task are suppressed mainly for regions in which misdetection or underdetection tends to occur in a sub-task which is a recognition task related to the same category as the main task. Therefore, even with such a configuration, it is possible to efficiently perform training so as to improve the estimation accuracy of the main task.

Furthermore, the weighting of the loss of the main task may be performed based on the error map of the main task, and the weighting of the loss of the sub-task may be performed based on the error map of a sub-task. For example, the weighting unit 122 may decide a weight of the loss of the main task based on the error map of the main task, for each pixel of the estimation map of the main task, corresponding to each position of the training image. In addition, the weighting unit 122 may decide a weight of the loss of the sub-task based on the error map of the sub-task, for each pixel of the estimation map of the sub-task. The weight decided in this manner can be similarly used by the loss calculation unit 123 in step S404. Such a configuration may be used in combination with a configuration for performing weighting of the loss of the main task based on the error map of the main task, and a configuration for performing the weighting of the loss of a sub-task based on the error map of the sub-task, or it may be used in place of these configurations. In such a configuration, in particular, it is possible to use the error map described in the second embodiment, in which a plurality of error distributions corresponding to the training image are accumulated. In this case, it is possible to realize efficient training because the weighting for a region in which an error detected at an initial stage of training is likely to occur can be successively performed even in subsequent training. In particular, in a configuration in which the weight of the loss of the main task is decided based on the error map of the main task, it is not essential for the neural network to perform a sub-task.

Also, in one embodiment, weighting of the loss of a task using an error map may be omitted. As described above, since a sub-task is a recognition task related to the same category as the main task, the estimation accuracy of the main task can also be increased by training the neural network so as to increase the estimation accuracy of the sub-task. In particular, in a configuration in which the result of the sub-task is obtained from the intermediate layer, training based on the sub-task can be performed from the intermediate layer. Therefore, it is possible to efficiently perform training for extracting features useful for estimation in the main task in a shallow layer of the neural network. In addition, when a task that is easier than the main task (for example, a task with a small amount of information obtained by detection) is used as a sub-task, training in a shallow layer of the neural network proceeds more efficiently because training is easy. Therefore, even with such a configuration, it is possible to efficiently perform training so as to improve the estimation accuracy of the main task.

### Second Embodiment

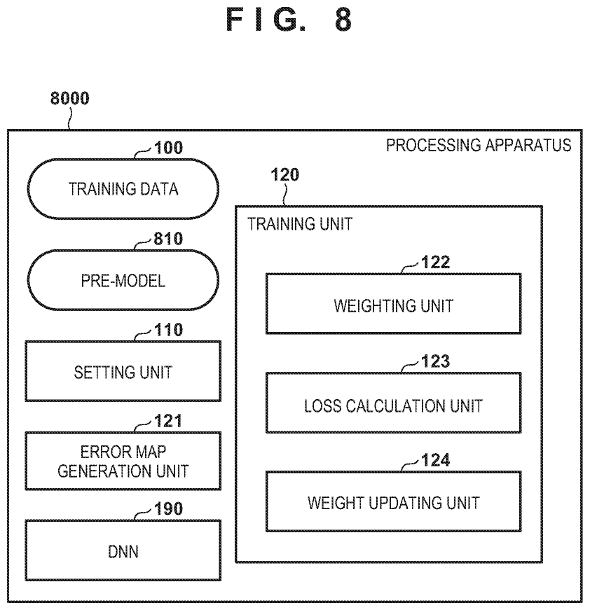

FIG. 8 illustrates a configuration of a processing apparatus 8000 according to the second embodiment. The present embodiment differs from the first embodiment in that the error map generation unit 121 is independent of the training unit 120. The processing apparatus 8000 according to the present embodiment includes a pre-model 810. Other configurations are similar to those of the first embodiment, and different points will be described below.

The pre-model 810 is a DNN that performs the same recognition task as the main task in the processing apparatus 8000. The pre-model 810 may be the DNN 190 that is untrained and where the weighting coefficients of the respective layers are in an initial state, or may be the DNN 190 after a training process using the training data 100 has been executed a predetermined number of times.

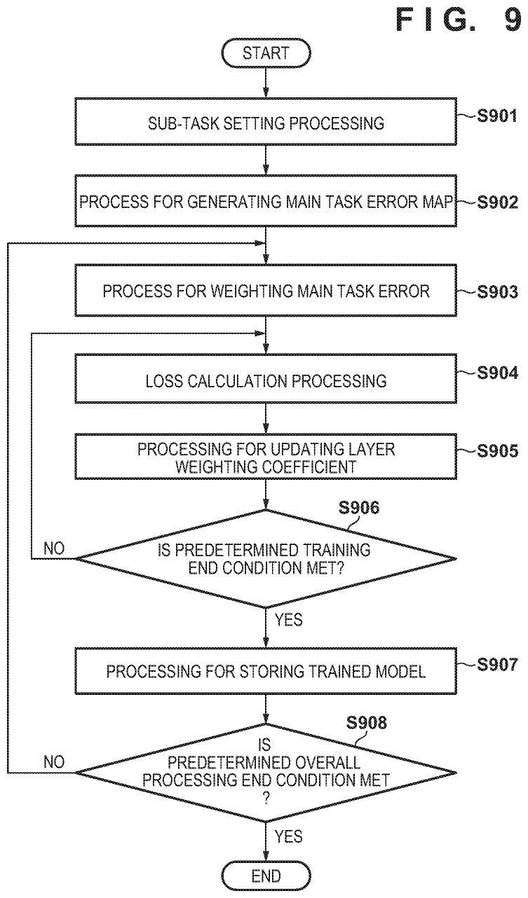

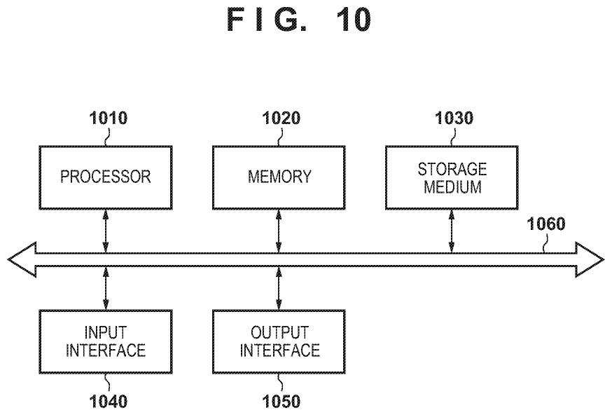

The flow of processing in the second embodiment will be described with reference to the flowchart illustrated in FIG. 9. The step S901 is performed similarly to step S401 of the first embodiment.

In step S902, the error map generation unit 121 creates an error map of the main task. The error map generation unit 121 in the present embodiment generates an error map based on the error between the detection result of the first type obtained by inputting the training image to a neural network before training, and the first supervisory data. For example, for each of all the training images, the error map generation unit 121 generates an estimation map of the main task by inputting the training image to the pre-model 810. Then, the error map of the main task corresponding to each training image is created using the obtained estimation map and the supervisory image. As described above, the pre-model 810 can be used as a neural network before training. However, a neural network that is in the middle of training may be used as a neural network before training. The creation of the error map can be performed as in step S402 in the first embodiment, and the explanation thereof is omitted.

Unlike in the first embodiment, the process of step S902 can be performed independently of the training of the DNN 190. In the first embodiment, the error map corresponding to a specific training image is successively updated during the training of the DNN 190. In contrast, in the present embodiment, the values of the error map corresponding to the specific training image are fixed at least for a predetermined period of time during the training of the DNN 190 (for example, one loop of step S902 to step S907 which are described later).

The process of step S903 to step S905 can be performed in the same manner as in step S403 to step S405 of the first embodiment. Note that, in step S403, the weighting unit 122 weights the loss of the sub-task for each position of the training image using the error map corresponding to the training image from among error maps created in step S902. Then, in step S404 to step S405, the loss calculation unit 123 and the weight updating unit 124 can perform further training of the trained neural network. Here, the trained neural network is the current neural network being trained, and the weighting factor is updated in comparison to a neural network before training, such as the pre-model 810 used to generate the estimation map. The loss calculation unit 123 and the weight updating unit 124 can perform training by using the detection result of the second type and the detection result of the first type obtained by inputting the training image to the neural network after training, and the error map.

In step S906, the weight updating unit 124 determines whether or not a predetermined training end condition is satisfied. If the end condition is not satisfied, the process returns to step S903, and then the process of step S903 to step S905 is repeated until the end condition is satisfied. The processing of step S902 to step S905 may be performed using a new training image, or may be performed again using a training image used previously. If the end condition is satisfied, the process proceeds to step S907. The end condition is not particularly limited, and may be set in advance by the user. For example, when the processing loop of step S903 to step S905 has been performed a predetermined number of times, the training process can end. In step S907, the weight updating unit 124 stores the DNN 190 after training has been performed as a trained model.

In step S908, the weight updating unit 124 determines whether or not a predetermined processing end condition is satisfied. If the end condition is not satisfied, the process returns to step S902, and then the process of step S902 to step S907 is repeated until the end condition is satisfied. The processes of steps S902 to 907 may be performed using the previously used training images again, but in this instance, a new error map generated in step S902 can be used after step S903. When the end condition is satisfied, the process of FIG. 9 ends. The end condition is not particularly limited, and may be set in advance by the user. For example, when the processing loop of step S902 to step S907 has been performed a predetermined number of times, the training process can end. In addition, the training process may end when the detection accuracy of the DNN 190 exceeds a predetermined threshold value.

In step S902 in the second and subsequent processing loop of step S902 to step S907, the error map generation unit 121 can create the estimation map using the trained model stored in step S907 instead of the pre-model 810. According to such processing, it is possible to create an error map of the main task that reflects the error distribution information in the latest training.

Meanwhile, in step S902, the error map generation unit 121 can use the error between the detection result of the first type obtained by inputting the training image to a neural network before training, and the first supervisory data. In such a case, the error map generation unit 121 can generate an error map, to be used in further training, based on the error between the detection result of the first type obtained by inputting the training image to a neural network after training, and the first supervisory data. For example, the error map generation unit 121 may create a new error map by referring to an error map created in the past.

As a specific example, instead of newly creating an error map in the processing loop of step S902 to step S907, the error map generation unit 121 may update a previously created error map such that the latest error distribution information is accumulated. For example, the error map generation unit 121 can update the error map of the main task created in the previous loop so that the pixel values of a new misdetection or underdetection region becomes 1 and pixel values of other regions are maintained. The specific update method is not particularly limited, and can be determined by the user. For example, the error map generation unit 121 can accumulate the latest five pieces of error map information. As a specific example, the error map generation unit 121 may generate an error map indicating a region in which misdetection or underdetection has occurred in at least one of the latest five estimation maps. In addition, it is possible for the error map generation unit 121 to use the error map created using the pre-model 810 only in the first loop, and subsequently accumulate an error map created using the trained model, and use the error map obtained by accumulation.

In the first embodiment, an error map is created for a training image used for training, and the loss in a region where an error is likely to occur is weighted. In contrast, in the second embodiment, weighting of error-prone regions can be performed more appropriately while continuing training. More specifically, by, even in subsequent training, continuously weighting a region in which an error detected at the initial stage of training is likely to occur, more efficient training can be performed so that misdetection or underdetection is suppressed.

### Third Embodiment

In the first and second embodiments, training is performed so as to efficiently suppress an error in a region where an error tends to occur by weighting loss in the region using the error map of the main task. However, a misdetection region in a certain task is often a region in which an object similar to a detection target is present. That is, there is a high possibility that an underdetection region is a region in which the detection target is present, whereas a misdetection region is a region in which a misdetection of an object similar to the detection target occurred. More specifically, in a task of detecting a head region, a round object such as a tire or a ball, or a region that is part of the same human body as the head, such as a hand or a torso, is likely to be misdetected as the head region. Further, in an underdetection region, there is a high possibility that the detection target is present in a specific state which is difficult to detect. For example, underdetection of a head region is likely to occur in a state in which the head faces backward or in a state in which a part of the head region is shielded. As described above, when an error occurs, it is highly likely that the subject has a specific characteristic. Therefore, it is expected that the detection accuracy of the main task is also improved by training the neural network so that an object similar to the detection target or a specific characteristic of the subject can be easily discriminated.

In the third embodiment, sub-tasks are configured such that a detection result of the second type (or sub-task result) indicates a detection error for a detection result of the first type (or main task result). The loss calculation unit 123 uses the error map of the main task as the second supervisory data (or the supervisory data of the sub-task). As a specific example, a task of detecting a region where an error is likely to occur in a main task is used as a sub-task, and training of a neural network is performed so that the error of the sub-task is reduced. According to such a configuration, training of the neural network is performed so that an object similar to the detection target or a specific characteristic of the subject can be easily extracted as a feature. Therefore, it is possible to efficiently perform training so that misdetection or underdetection in the main task is suppressed.

The processing apparatus according to the third embodiment is similar to the processing apparatus 8000 according to the second embodiment except that it does not have the weighting unit 122. The processing according to the third embodiment can be performed as in FIG. 9. Hereinafter, a configuration and processing different from that of the second embodiment will be described. The processing apparatus 1000 according to the first embodiment, which does not have the weighting unit 122, can be used in a similar manner.

In the present embodiment, a recognition task of an error-prone region in the main task is used as a sub-task. As a supervisory image of the sub-task, the error map created by the error map generation unit 121 can be used. In the present embodiment, a task of detecting a region with an error actually occurred when a training image is input to the pre-model 810 (or the stored trained model) can be used as a sub-task. In this case, the error map, created by the error map generation unit 121 based on the estimation map obtained when the training image is input to the pre-model 810 (or a stored trained model), can be used as a supervisory image.

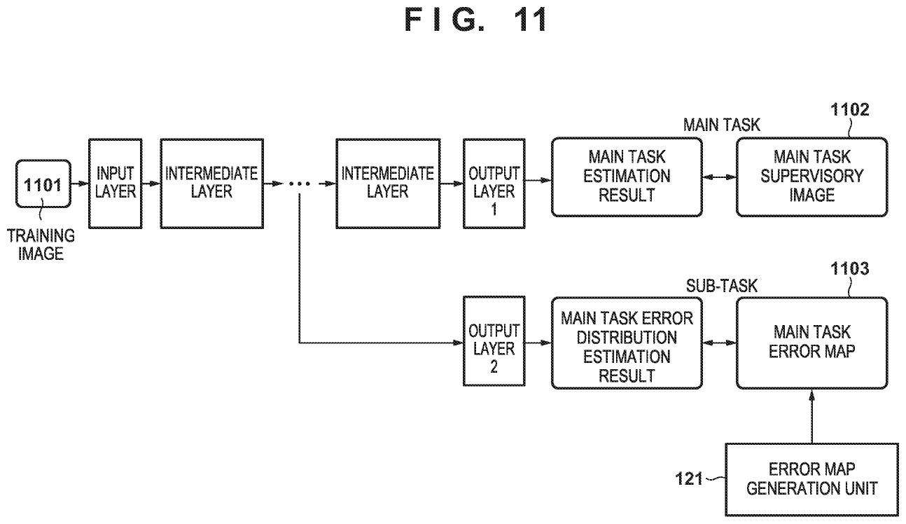

FIG. 11 illustrates an example of the DNN 190 set in the present embodiment. As the training data, a training image 1101, a supervisory image 1102 of the main task prepared in advance, and an error map 1103 of the main task created by the error map generation unit 121 are stored in association with each other. In the present embodiment, the supervisory image 1102 is set as supervisory data of a main task with respect to a certain training image 1101, and the error map 1103 is set as supervisory data of a sub-task.

Hereinafter, processing in the present embodiment will be described with reference to FIG. 9. In step S901, the setting unit 110 sets sub-tasks as described above. In the present embodiment, the supervisory image of a sub-task is generated by the error map generation unit 121 in step S902. The process of step S902 can be performed in a similar manner as in the second embodiment.

In the present embodiment, the error map of the main task is not used for weighting the losses of the sub-task, but is used as a supervisory image of the sub-task, so that step S903 can be omitted. The processing of step S905 to step S908 can be performed in a similar manner as in the second embodiment.

On the other hand, weighting may be performed on the loss of the main task using the error map of the main task. Further, in step S901, the setting unit 110 may set a further sub-task that differs from the sub-task that estimates the error distribution of the main task. In this case, the loss of the further sub-task may be weighted using the error map of the main task in a similar manner to as in Embodiment 2. In this instance, a process corresponding to step S903 is performed for each the task.

In the present embodiment, the training of a region similar to the detection target of the main task is performed in parallel with the training for detecting the detection target of the main task. By performing such training, it is possible to perform training of the neural network so that misdetection or underdetection in the main task is suppressed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-Ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-226721, filed Dec. 3, 2018, which is hereby incorporated by reference herein in its entirety.

What is claimed is:

1. A training apparatus for training a neural network, the neural network being configured to, when an input image is inputted, output a detection result of a first type and a detection result of a second type for each position of the input image,
the training apparatus comprising:
a training data obtaining unit configured to obtain a training image to be input to the neural network for training;
an error map obtaining unit configured to obtain an error map indicating a detection error for a detection result of the first type, for each position of the training image; and
a training unit configured to train the neural network using the detection result of the first type and the detection result of the second type that are obtained by inputting the training image to the neural network, and the error map.

2. The training apparatus according to claim 1, wherein the detection result of the second type can be generated from the detection result of the first type.

3. The training apparatus according to claim 1, wherein the error map indicates a position of an underdetection region or a misdetection region caused by a detection error in the detection result of the first type.

4. The training apparatus according to claim 1, wherein the neural network includes an input layer to which the image is inputted, an intermediate layer in which processing is performed, a first output layer for outputting the detection result of the first type, and a second output layer that branches from the intermediate layer and is for outputting the detection result of the second type.

5. The training apparatus according to claim 1, wherein
the training data obtaining unit is further configured to obtain first supervisory data indicating a detection result of the first type that is prepared in advance for the training image, and
the error map obtaining unit is further configured to generate the error map based on an error between the first supervisory data and the detection result of the first type obtained by inputting the training image to the neural network.

6. The training apparatus according to claim 5, wherein
the error map obtaining unit is further configured to generate the error map based on an error between the first supervisory data and the detection result of the first type obtained by inputting the training image to a neural network before training, and
the training unit is further configured to use a detection result of the first type and a detection result of the second type obtained by inputting the training image to a neural network after the training, and the error map to perform further training of the neural network after the training.

7. The training apparatus according to claim 5, wherein
the error map obtaining unit is further configured to, based on
an error between the first supervisory data and the detection result of the first type obtained by inputting the training image to a neural network before training, and
an error between the first supervisory data and the detection result of the first type obtained by inputting the training image to a neural network after the training,
generate the error map used in further training of the neural network after the training.

8. The training apparatus according to claim 1, wherein the training data obtaining unit is further configured to obtain first supervisory data of the first type and second supervisory data of the second type, which are prepared in advance for the training image.

9. The training apparatus according to claim 8, wherein
the training unit is further configured to train the neural network based on an error between the detection result of the first type and the first supervisory data, and an error between the detection result of the second type and the second supervisory data.

10. The training apparatus according to claim 9, wherein the training unit is further configured to use a detection error in the detection result of the first type to weight, for each position of the training image, the error between the detection result of the second type and the second supervisory data.

11. The training apparatus according to claim 9, wherein
the detection result of the second type indicates a detection error for the detection result of the first type, and
the training unit uses the error map as the second supervisory data.

12. The training apparatus according to claim 8, wherein the detection result of the second type and the detection result of the first type indicate different information with respect to a detection target of the same type.

13. The training apparatus according to claim 8, wherein the training data obtaining unit is further configured to generate the second supervisory data using the first supervisory data.

14. The training apparatus according to claim 1, wherein the neural network is configured to output the detection result of the first type and the detection result of the second type for each position of the input image as an estimation map.

15. The training apparatus according to claim 14, wherein the error map obtaining unit is further configured to generate the error map for the detection result of the first type based on first supervisory data and the estimation map representing the detection result of the first type.

16. The training apparatus according to claim 1, wherein the detection result of the first type is a region of a predetermined object, and the detection result of the second type is a region of a specific portion of the predetermined object.

17. A processing apparatus for outputting an estimation map, the estimation map indicating a detection result for each position of an input image, the processing apparatus comprising:
a neural network trained by a training apparatus, the neural network being configured to, when the input image is inputted, output the detection result of a first type and the detection result of a second type for each position of the input image, the training apparatus comprising:
a training data obtaining unit configured to obtain a training image to be input to the neural network for training;
an error map obtaining unit configured to obtain an error map indicating a detection error for a detection result of the first type, for each position of the training image; and
a training unit configured to train the neural network using the detection result of the first type and the detection result of the second type that are obtained by inputting the training image to the neural network, and the error map; and
a generation unit configured to generate the estimation map by inputting input images to the neural network.

18. A neural network for outputting, as an estimation map, a detection result for each position of an input image, the neural network comprising:
an input layer to which the input image is inputted;
an intermediate layer in which processing is performed; and
an output layer configured to output the detection result,
wherein the neural network is trained such that a different detection result that can be generated from the detection result is obtained from the intermediate layer.

19. A method of training a neural network, the neural network being configured to, when an input image is inputted, output a detection result of a first type and a detection result of a second type for each position of the input image, the method comprising:
obtaining a training image to be input to the neural network for training;
obtaining an error map indicating a detection error for a detection result of the first type, for each position of the training image; and
training the neural network using the detection result of the first type and the detection result of the second type that are obtained by inputting the training image to the neural network, and the error map.

20. A non-transitory computer-readable medium storing a program which, when executed by a computer comprising a processor and a memory, causes the computer to perform:
obtaining a training image to be input to the neural network for training, the neural network being configured to, when an input image is inputted, output a detection result of a first type and a detection result of a second type for each position of the input image,
obtaining an error map indicating a detection error for a detection result of the first type, for each position of the training image; and
training the neural network using the detection result of the first type and the detection result of the second type that are obtained by inputting the training image to the neural network, and the error map.
